(19) United States
(12) Patent Application Publication
(10) Pub. No.: US 2006/0122759 A1
(43) Pub. Date: Jun. 8, 2006

(54) System and method for vehicle braking

(76) Inventors: Max Leyten, Vaals (NL); Mark Eifert, Muenchen (DE)

Correspondence Address: FORD GLOBAL TECHNOLOGIES, LLC., FAIRLANE PLAZA SOUTH, SUITE 800, 330 TOWN CENTER DRIVE, DEARBORN, MI, 48126, US

(21) Appl. No.: 11/295,249

(22) Filed: Dec. 6, 2005

(30) Foreign Application Priority Data
Dec. 6, 2004 (EP) 04106321.5

(51) Int. Cl. G06F 19/00

(52) U.S. Cl. 701/70

(57) ABSTRACT

An inventive method for braking a vehicle when traveling on a negative gradient, which vehicle is equipped with a vehicle engine and a controllable vehicle generator which is connected to the vehicle engine in order to convert some of the engine power into electrical power.

The present invention relates to a method for braking a vehicle when traveling on negative gradients, which vehicle is equipped with a vehicle engine and a controllable vehicle generator which is connected to the vehicle engine in order to convert some of the engine power into electrical power. Furthermore, the invention relates to a brake device and to a vehicle which is equipped with a brake device.

### BACKGROUND

Devices for braking are standard equipment in a large number of vehicles nowadays. For example, in motor vehicles, what are referred to as permanent brake systems are known. The “handbrake or parking braking system” of a motor vehicle is taken to refer to the permanent braking system of the vehicle, that is typically actuated when the vehicle has come to a permanent stop, for example when the vehicle is parked. Alternatively, the permanent braking system may be employed while waiting at traffic lights. Therefore, a “permanent stop” is defined herein as a stoppage of the motor vehicle such that a passenger may safely emerge from the vehicle, and is often associated with the engine being in a neutral gear and, or, switched off. This is in contrast to a “temporary stop”, where only the footbrake system is used, and the engine is typically engaged with the first or other gear, to allow the vehicle to move at any time. The permanent brake system is commonly actuated by a hand actuated lever, but there are many examples of pedal-actuated variants.

Permanent braking systems are often used in particular for traveling on negative gradients. Such a permanent braking system is described in DE 36 02 312 A1. This permanent braking system is embodied as an electric brake, also referred to as an electric retarder, in which eddy currents are used to generate a braking torque. In passenger vehicles, such permanent brake systems are however generally not applied since the installation space required is frequently not available.

However, traveling down steep mountain passes, for example in Switzerland, Austria or Italy, also leads to extreme situations in passenger vehicles for the vehicle engine and for the driver of the vehicle. Braking using the drag torque of the vehicle engine often adversely affects the driving comfort owing to increased passenger compartment noise resulting from the high engine speed. If the drag torque of the engine is not sufficient to brake the vehicle in the selected gear speed, the driver must additionally shift down in order to increase the braking torque available at the tires by increasing the engine speed. This increases the passenger compartment noise further. If the incline is very steep, up to 20% in the case of mountain passes is not unusual; it is also insufficient to brake using the drag torque of the vehicle engine. As a consequence, the friction brake of the vehicle must be applied in order to keep the vehicle velocity at least constant. This leads to excessive wear on the brake disk and brake lining. In extreme cases overheating may also occur, which may cause the braking force to drop and thus bring about a dangerous situation.

Therefore, what is need is a new brake device and method for braking a vehicle when traveling on a negative gradient.

### SUMMARY OF INVENTION

The present invention discloses a method for braking a vehicle, the vehicle having an engine and a controllable vehicle generator connected to the engine in order to convert some of the engine power into electrical power comprising the following inventive steps. During the first step, the method checks whether the vehicle is traveling on a negative gradient. During the next step, it determines a manipulated variable for the vehicle generator. Finally, it outputs the determined manipulated variable to the vehicle generator. The manipulated variable places the vehicle generator in an operating state suitable for a constant engine speed if the checking reveals that the vehicle is traveling on a negative gradient.

The constant engine speed leads here to a situation in which the vehicle travels down a negative gradient with a constant velocity. As a result, the driving comfort is increased, the need to use the friction brake is reduced and the driving safety is increased. It is not necessary to install an additional brake device which takes up space, for example a retarder, in this context since the braking effect is made available by the generator which is present in any case. In addition, in the operating state in which the engine speed is kept constant the generator can be used to convert a large part of the engine power into electrical power. This both reduces the need for cooling and permits the vehicle battery to be charged.

Conventional generators, integrated starter generators or even electrical traction motors are possible as vehicle generators.

In a vehicle which is equipped with at least one vehicle parameter sensor which is designed to sense a vehicle parameter which is suitable for identifying travel on a negative gradient, the checking whether the vehicle is traveling on a negative gradient can be carried out by checking to determine whether the vehicle parameter which is sensed by the at least one vehicle parameter sensor leads to the identification of travel on a negative gradient. Various vehicle parameters are suitable for this purpose. For example, an inclination sensor could be integrated into a vehicle and could be used to detect travel on a negative gradient. However, the detection of travel on a negative gradient does not need to be carried out by reference to a single vehicle parameter but it is also possible to use a combination of a plurality of vehicle parameters to detect travel on a negative gradient. In one advantageous refinement of the method according to the invention, one or more of the following vehicle parameters can be used individually or in combination in order to detect travel on a negative gradient: vehicle velocity, engine speed, throttle valve position, brake pedal position, transmission ratio. The aforesaid vehicle parameters are generally available in any case in modern vehicles so that no additional sensors have to be installed in a vehicle in order to carry out the method according to the invention.

In one advantageous refinement of the method according to the invention, the checking whether the vehicle is traveling on a negative gradient is carried out repeatedly. If the checking reveals that the vehicle is no longer traveling on a negative gradient, a manipulated variable which restores the original operating state of the vehicle generator is output. This ensures that the braking effect of the vehicle generator is eliminated again after the travel on a negative gradient has ended.

Before the manipulated variable for the vehicle generator is determined, a target engine speed which is to be reached can be determined if the checking reveals that the vehicle is traveling on a negative gradient. The manipulated variable is then determined in such a way that it is suitable for placing the generator in an operating state which leads to an operating state with the target engine speed when the engine is connected to the vehicle generator. In this way, the engine speed and thus the braking effect can be adapted to the current driving situation. For example, a greater braking effect may be desired on a steep negative gradient than on a less steep negative gradient. In order to determine the target engine speed it is possible, for example, to sense the engaged gear speed. The optimum rotational speed for the engaged gear speed can then be used for example as a target engine speed.

In one development of the method according to the invention, checking is carried out to determine whether the vehicle is traveling on a positive gradient. If the checking reveals that the vehicle is traveling on a positive gradient, a manipulated variable for the vehicle generator is determined, which variable is suitable for placing the generator in an operating state in which the portion of engine power which is converted into electrical power is reduced in comparison with the customary operating state, that is to say the operating state when traveling on a level section of road. This manipulated variable is finally output to the vehicle generator. As a result, the traction force which is available at the tires in order to travel up the gradient is maximized.

If the vehicle comprises, as is generally conventional, an energy accumulator (for example vehicle battery) for storing electrical energy resulting from the engine power converted by the vehicle generator it is possible to determine the profile of the travel on a positive gradient in advance by determining the position of the vehicle and comparing the position of the vehicle with map material, and to define the manipulated variable for the case of travel on a positive gradient in such a way that the energy accumulator is largely emptied after the vehicle has finished traveling on a positive gradient. Largely emptied is intended to mean here that, for example, the vehicle battery is emptied to the minimum level at which the function of the on-board electronics of the vehicle or the starting of the engine can still be ensured. With this configuration of the method according to the invention it is possible, on the one hand, to improve the travel of the vehicle on a positive gradient and on the other hand to ensure that a large absorption capacity for the energy generated by the vehicle generator during the subsequent travel on a negative gradient is available in the energy accumulator after the positive gradient has ended. In this way it is possible to ensure that sufficient capacity for absorbing the generated electrical energy is available even for relatively long periods of travel on negative gradients.

An inventive brake system for a vehicle, the vehicle having a controllable generator connected to an engine, the system comprises at least one sensor suitable for sensing at least one vehicle parameter for identifying vehicle travel on a negative gradient. The system also has a control unit having a signal input unit for receiving the at least one vehicle parameter and a signal output unit for outputting a manipulated variable for controlling the generator. The control unit determines the manipulated variable as a function of the at least one vehicle parameter for generating a brake torque to achieve a constant engine speed.

The brake device according to the invention is suitable for carrying out the method according to the invention and thus permits the advantages which are to be achieved with the method according to the invention to be implemented in a vehicle.

In one development of the brake device according to the invention, the signal input unit is also designed to receive a reference variable which represents a target engine speed. As a result, different target engine speeds can be fed to the brake device depending on requirements.

A vehicle according to the invention comprises an engine, at least one vehicle parameter sensor for sensing at least one vehicle parameter which is suitable for identifying travel on a negative gradient, and a vehicle generator which is connected to the vehicle engine in order to convert part of the engine power into electrical power. The method according to the invention also comprises a brake device according to the invention. In the vehicle according to the invention, the signal input unit of the brake device according to the invention is connected to at least one of the vehicle parameter sensors for receiving a vehicle parameter. Furthermore, the vehicle generator is connected to the signal output unit of the brake device according to the invention in order to receive the actuating signal. In this context, at least one of the following sensors can be used as a vehicle parameter sensor: engine speed sensor, vehicle velocity sensor, throttle valve position sensor, brake pedal position sensor, transmission ratio sensor.

If the vehicle comprises a gear speed sensor for determining the engaged gear speed and said sensor is connected to the signal input unit in order to output a variable representing an engaged gear speed as the reference variable representing the target engine speed, the engine speed can be set as a function of the engaged gear speed when the vehicle is traveling on a negative gradient.

In a further refinement, the vehicle may comprise both an energy accumulator, for example the vehicle battery, and an auxiliary energy accumulator, for example a capacitor, which is connected in parallel with the energy accumulator. The auxiliary energy accumulator makes it possible for energy which is output by the vehicle generator to continue to be stored even if the energy accumulator is completely full.

### BRIEF DESCRIPTION OF THE DRAWINGS

Further features, properties and advantages of the present invention emerge from the subsequent description of an exemplary refinement with reference to the appended figures:

FIG. 1 shows a block circuit diagram of the brake device according to the invention and selected vehicle components, and

FIG. 2 shows a diagram verifying the method according to the invention.

### A DETAILED DESCRIPTION OF THE PREFERRED EMBODIMENTS

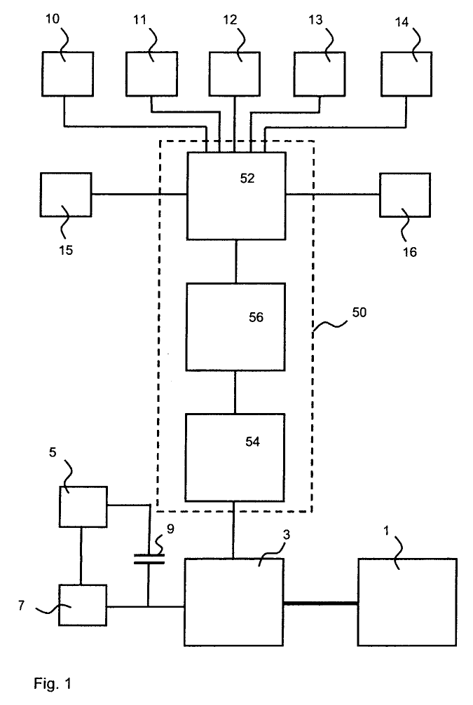

FIG. 1 shows in a schematic block circuit diagram components of a vehicle in conjunction with a brake device according to the invention. Only elements of the vehicle which are necessary to explain the brake device are illustrated for the sake of clarity. However, the vehicle can of course also have any other components which are usually present in vehicles.

The vehicle is equipped with a vehicle engine 1 which may be embodied, in particular, as an internal combustion engine, for driving the vehicle. In order to convert part of the engine power into electrical power, the vehicle also has a vehicle generator 3. In the present exemplary refinement, the latter comprises a magnetic rotor which is mechanically coupled to the engine 1 and an inductor which surrounds the rotor and has a coil winding. The mechanical coupling of the rotor to the vehicle engine, which can be brought about using, for example, a shaft, has the purpose of transmitting the rotary movement made available by the engine to the rotor. The mechanical power is then converted into electrical power by exciting currents in the coil winding by means of the rotating rotor.

The vehicle generator 3 then makes available the electrical power to the vehicle's on-board electrical system in order to be able to operate the electronic components of the vehicle. Power which is not required by the vehicle's on-board electrical system 5 is output to a vehicle battery 7 which serves as an energy accumulator.

The vehicle also comprises a vehicle velocity sensor 10 for determining the vehicle velocity, an engine speed sensor 11 for determining the engine speed, a throttle valve position sensor 12 for determining the position of the throttle valve of the vehicle, a brake pedal position sensor 13 for determining the brake pedal position and a transmission ratio sensor 14 for determining the transmission ratio.

The method according to the invention comprises a brake device 50 according to the invention with a signal input unit 52 which has a signal connection to the abovementioned vehicle sensors. The brake device 50 also comprises a signal output unit 54 which has a signal connection to the vehicle generator 3. Finally, the brake device comprises a control unit 56 which is connected both to the signal input unit 52 for receiving the incoming signals and to the signal output unit 54 for outputting an actuating signal. Furthermore, a gear speed sensor 15 for determining the engaged gear speed and a velocity control unit 16 may be connected to the signal input unit 52 of the brake device 50. The signal input unit 52 can receive, from the velocity control unit 16, a signal which represents the vehicle velocity which has been set.

The method of operation of the brake device 50 according to the invention is described below.

The brake device 50 has the purpose of outputting an actuating signal to the vehicle generator 3 when the vehicle is traveling on a negative gradient, which actuating signal places said vehicle generator 3 in an operating state which leads to an operating state with a constant engine speed at the engine 1 via the mechanical coupling. This may be brought about, for example, by virtue of the fact that an actuating signal which causes a current which brings about eddy currents in the rotor to flow through the winding of the stator is output to the vehicle generator 3 by the signal output unit 54 of the brake device 50. The eddy currents then counteract the rotation of the rotor and in this way generate a braking torque which is transmitted to the vehicle engine 1 via the mechanical coupling.

The braking torque which is transmitted to the engine 1 brings about a specific engine speed at the engine 1 and counteracts an increase in the engine speed beyond the specific engine speed so that a braking effect for the vehicle occurs. The rotational speed of the engine can be influenced here by means of the flow of current through the turns of the stator.

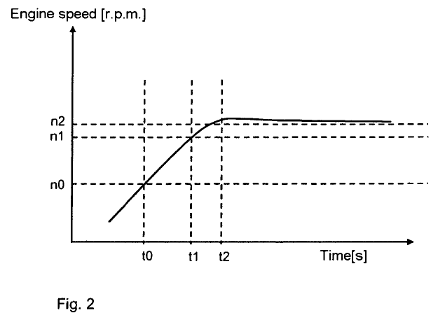

The brake device according to the invention serves as a sustained-action brake device for travel on a negative gradient by the vehicle. If the actuating signal which causes the braking torque is output to the vehicle generator 3, it has therefore previously been detected that the vehicle is traveling on a negative gradient. Detection of travel on a negative gradient by the vehicle takes place in the present exemplary refinement by reference to at least one vehicle parameter signal which is made available by the sensors 10 to 14. In the present exemplary refinement, either the vehicle velocity, the engine speed, the throttle valve position, the position of the brake pedal or the transmission ratio may be used alone or the above may be used in combination. For example, travel on a negative gradient can be inferred from the vehicle velocity in conjunction with the throttle valve combination. Likewise, the engine speed is suitable as a parameter for detecting travel on a negative gradient. This will be briefly explained with reference to the diagram illustrated in FIG. 2. Engine speeds n₀ and n₁ are measured at various times t₀, t₁ by reference to the rotational speed sensor. A change in the engine speed can be determined from the difference between the engine speeds and the time interval between the measuring points, and in this case the term gradient of the engine speed is used. If the gradient rises in excess of a specific value, the control unit 56 detects travel on a negative gradient. The threshold value at which the travel on a negative gradient is detected should be selected here in such a way that it cannot be reached by actuating the accelerator pedal.

In the present exemplary refinement, travel on a negative gradient is detected by reference to a combination of the vehicle parameter data items made available by the sensors 10 to 14. The combination enables the clarity of information to be increased when detecting travel on a negative gradient. Travel on a negative gradient can be detected by the control unit 56 if, for example, the following conditions are fulfilled in combinations.

The vehicle velocity exceeds a specific value.

The brake pedal is not activated.

The throttle valve position is zero degrees,

The engine speed increases at a specific rate which is above a predefined value.

The transmission ratio is also used to interpret these parameters.

At this point it is to be noted that sensors other than those described in the exemplary refinement can also be used to detect travel on a negative gradient. For example, the vehicle may be equipped with an inclination sensor which detects the inclination of the vehicle. Travel on a negative gradient can be detected, for example, if the inclination of the vehicle exceeds a specific inclination threshold value over a specific time period.

If it is detected in the described procedure that the vehicle is traveling on a negative gradient, the control unit 56 causes the actuating signal which brings about the braking torque to be output via the signal output unit 54 to the vehicle generator 3.

The engine speed which is to be set in the vehicle engine 1 on the basis of the braking torque, referred to below as target engine speed, depends here on the engaged gear speed. In order to make available a reference variable which represents the target rotational speed, the vehicle is equipped with a gear speed sensor 15 which passes on a signal representing the engaged gear speed to the signal input unit 52 of the brake device 50. The engine speed which is optimum for the engaged gear speed can then serve, for example, as a basis for the reference variable which represents the target rotational speed to be brought about in the vehicle engine 1. The control unit 56 can use this reference variable to determine a corresponding actuating signal for the vehicle generator 3, which signal brings about the engine speed to be attained. The logical combination of the reference variable and the manipulated variable can occur in the control unit 56 either in the form of a table or in the form of a functional relationship.

The reference variable can alternatively also be made available by the velocity control system 16 instead of by the gear speed sensor 15.

In the exemplary refinement, the detection whether the vehicle is traveling on a negative gradient takes place at regular time intervals. If it is detected in the process that the vehicle is no longer traveling on a negative gradient, the control unit 56 returns the vehicle generator 3 to its customary operating state.

When the vehicle is braked by means of a friction brake or engine brake, the brake energy is essentially converted into heat. In contrast, in the method according to the invention for braking of a vehicle when it is traveling on a negative gradient, a large part of the brake energy is converted into usable electrical energy. Insofar as this electrical energy is not consumed by the vehicle's on-board electrical system 5 it is passed on to the battery 7 for storage. However, when long journeys on negative gradients occur the battery may not be capable of storing all the electrical energy resulting from the braking energy. In order to avoid this situation, three procedures are possible. On the one hand, as illustrated in FIG. 1, a large capacitor 9 of the battery 7 may be connected in parallel as an energy buffer. The second possibility is to ensure that the battery 7 is largely emptied before the start of the travel on a negative gradient. However, the emptying should only occur here to such an extent that the electrical functions of the vehicle, including the restarting of the engine, can also continue to be ensured. The third possibility is to switch on additional large loads such as, for example, the heatable windshield.

The possibility of emptying the battery 7 is appropriate, for example, if the travel on a negative gradient is preceded by travel on a positive gradient as is the case, for example, when traveling through passes. In such a case, travel on a positive gradient can be detected in a similar way to the detection of travel on a negative gradient by using the parameters made available by the sensors 10 to 14. If, in addition, the position of the vehicle is determined, for example by means of the global positioning system (GPS), the control unit 56 may infer the duration of the travel on a positive gradient from a comparison of the position of the vehicle with a map. In addition, the control unit 56 can determine the electrical energy which is required to terminate the uphill travel from the electrical power required by the vehicle's on-board electrical system. On the basis of this knowledge, as the vehicle travels on the positive gradient the vehicle generator 3 can be placed, by means of an actuating signal, in an operating state in which the conversion of mechanical power into electrical power is reduced or even entirely shut down in an extreme case. The degree of reduction depends here on how much energy the battery 7 can supply until the minimum required battery charge is reached. In this way it is possible to ensure that the battery is discharged to a maximum extent at the start of the travel on a negative gradient and provides a large capacity for absorbing electrical energy resulting from the braking process.

If the engine speed continues to rise when the vehicle travels down a negative gradient even though the generator 3 is already making available the maximum possible braking torque, the driver of the vehicle must still shift back, even if the brake device according to the invention is present, or can use the friction brakes of the vehicle in parallel with the brake device according to the invention. Nevertheless, the brake device 50 according to the invention reduces the use of the friction brake owing to the braking torque which is made available by the generator 3, which reduces the wear on the brake linings and the brake disks.

Compared to the braking behavior according to the prior art, the method according to the invention for braking a vehicle when it travels on a negative gradient has the advantage that the braking energy is not uselessly lost in the form of heat but instead is converted into useful electrical energy. Furthermore, the method according to the invention is capable of bringing about a constant engine speed and in addition is completely controllable.

The brake device according to the invention can be used in vehicles of any size. In particular it is also possible for the brake system according to the invention to be used in passenger vehicles which do not make available the installation space which is required to install sustained-action brake systems according to the prior art. In the case of utility vehicles, the brake device according to the invention can be used to make available a velocity control system in combination with large electrical retarders.

The brake device according to the invention facilitates driving a vehicle on a negative gradient and at the same time permits simultaneous use of a velocity control system.

The invention is not restricted to use in vehicles with internal combustion engines. It can also be used in vehicles with hybrid engines or electric engines.

1. A method for braking a vehicle, the vehicle having an engine and a controllable vehicle generator connected to the engine in order to convert some of the engine power into electrical power, comprising the steps of:
checking whether the vehicle is traveling on a negative gradient;
determining a manipulated variable for the vehicle generator, and
outputting the determined manipulated variable to the vehicle generator
wherein the manipulated variable places the vehicle generator in an operating state suitable for a constant engine speed if the checking reveals that the vehicle is traveling on a negative gradient.

2. The method as claimed in claim 1, wherein the step of checking whether the vehicle is traveling on a negative gradient further comprises continuously checking at least one vehicle parameter sensor.

3. The method as claimed in claim 2, wherein the at least one vehicle parameter sensor is a vehicle velocity sensor.

4. The method as claimed in claim 2, wherein the at least one vehicle parameter sensor is an engine speed sensor.

5. The method as claimed in claim 2, wherein the at least one vehicle parameter sensor is a throttle valve position sensor.

6. The method as claimed in claim 2, wherein the at least one vehicle parameter sensor is a brake pedal position sensor.

7. The method as claimed in claim 2, wherein the at least one vehicle parameter sensor is a transmission ratio sensor.

8. The method as claimed in claim 1, further comprising the step of:
determining a target engine speed before the manipulated variable for the vehicle generator is determined
wherein the manipulated variable places the vehicle generator in an operating state having a constant engine speed equivalent to the target engine speed.

9. The method as claimed in claim 8, further comprising the step of:
sensing an engaged gear in order to determine the target engine speed.

10. A method for braking a vehicle, the vehicle having an engine and a controllable vehicle generator connected to the engine in order to convert some of the engine power into electrical power during a normal operating state, comprising the steps of:
checking whether the vehicle is traveling on a positive gradient;
determining a manipulated variable for the vehicle generator, and
outputting the determined manipulated variable to the vehicle generator
wherein the manipulated variable places the vehicle generator in an operating state that reduces the portion of engine power which is converted into electrical power in comparison with the normal operating state if the checking reveals that the vehicle is traveling on a positive gradient.

11. The method as claimed in claim 1 or claim 10, wherein the manipulated variable is determined by reference to a determination of a position of the vehicle and a comparison of the vehicle position with map material.

12. A brake system for a vehicle, the vehicle having a controllable generator connected to an engine, the system comprising:
At least one sensor suitable for sensing at least one vehicle parameter for identifying vehicle travel on a negative gradient;
a control unit having a signal input unit for receiving the at least one vehicle parameter and a signal output unit for outputting a manipulated variable for controlling the generator;
wherein the control unit determines the manipulated variable as a function of the at least one vehicle parameter for generating a brake torque to achieve a constant engine speed.

13. The brake system as claimed in claim 12, wherein the signal input unit receives a target engine speed.

14. A brake system for a vehicle, the vehicle having a controllable generator connected to an engine, the generator converting a portion of engine power into electrical power during a normal operating state, the system comprising:
At least one sensor suitable for sensing at least one vehicle parameter for identifying vehicle travel on a positive gradient;
a control unit having a signal input unit for receiving the at least one vehicle parameter and a signal output unit for outputting a manipulated variable for controlling the generator;
wherein the control unit determines the manipulated variable as a function of the at least one vehicle parameter for generating a brake torque and reduces the portion of engine power converted into electrical power in comparison with the normal operating state.

15. The brake system as claimed in claim 12, wherein the at least one sensor is an engine speed sensor.

16. The brake system as claimed in claim 12, wherein the at least one sensor is a vehicle velocity sensor.

17. The brake system as claimed in claim 12, wherein the at least one sensor is a throttle valve position sensor.

18. The brake system as claimed in claim 12, wherein the at least one sensor is a brake pedal position sensor.

19. The brake system as claimed in claim 12, wherein the at least one sensor is a transmission ratio sensor.

20. The brake system as claimed in claim 12, wherein the at least one sensor is a gear speed sensor for determining the engaged gear speed.

21. The brake system as claimed in claim 12, wherein the brake system is included in a motor vehicle.

22. The brake system as claimed in claim 21, the motor vehicle further comprising an energy accumulator connected to the generator.

23. The brake system as claimed in claim 22, the motor vehicle further comprising an auxiliary energy accumulator connected in parallel to the energy accumulator.

24. The brake system as claimed in claim 23, wherein the auxiliary energy accumulator is a capacitor.
